(19) United States
(12) Patent Application Publication
(10) Pub. No.: US 2022/0325484 A1
(43) Pub. Date: Oct. 13, 2022

(54) PORTABLE RAMP

(71) Applicant: Thomas W. BATCHELDER, Vassalboro, ME (US)

(72) Inventor: Thomas W. BATCHELDER, Vassalboro, ME (US)

(21) Appl. No.: 17/229,018

(22) Filed: Apr. 13, 2021

(51) Int. Cl. E01D 15/12; B65G 69/30

(52) U.S. Cl. CPC E01D 15/124; B65G 69/30

(57) ABSTRACT

A portable ramp having a central portion and two foldable lateral side portions, whereby the side portions of the ramp are hingedly attached to opposite sides of the central portion of the ramp and a pair of support members are located on the underside of the central portion of the ramp proximate to the hinges, so that the side portions of the ramp can be folded outward and downward to rest on the floor or ground when the portable ramp is deployed for use to travers over an obstacle, and the side portions of the ramp can be folded upwards and inwards when the portable ramp is not in use.

### BACKGROUND OF THE INVENTION

The present invention concerns the safety field in general and more specifically portable safety equipment that can be used in the construction industry.

On a construction job site, inevitably there is a need to move around heavy pieces of equipment, such as scissor lifts, dollies, etc., and inevitably there is some immovable object impeding movement, such as a floor sill, electrical wiring, lumber, etc. As a result, ad hoc methods for maneuvering the equipment over the obstacle arise, such as laying a sheet of plywood over the object, or a drywall panel, or even just rolling the equipment directly over the obstacle. These are not safe methods and can result in damage to the obstacle, damage to the equipment, and potentially injury to the worker. This situation also can occur in many other contexts, apart from construction sites, such as at loading docks, at entrances to walk-in coolers and freezers, and the like.

It is therefore shown that there is a need for an improved portable ramp that can be deployed as needed over obstacles to allow for the movement of equipment and other things over the obstacles.

It is therefore an object of the present invention to provide a portable ramp than can be deployed over obstacles, providing a stable, safe means for moving equipment over obstacles.

It is a further object of the present invention to provide a portable ramp that is light weight and easy to position and reposition.

It is yet a further object of the present invention to provide a portable ramp that can bear several thousand pounds of weight.

It is yet a further object of the present invention to provide a portable ramp that can be folded when not in use to minimize storage floor space needs.

Other objects of the present invention will be readily apparent from the description that follows.

### SUMMARY

The portable ramp of the present invention is comprised of five primary components: a central platform; a first support member and a second support member, both support members located at lateral sides of the central platform on its underside; and a pair of access ramps, each hingedly attached to a lateral side of the central platform proximate to one of the support members. When deployed, the support members raise the central platform a given height over a support surface, such as the floor or ground, allowing the central platform to be placed over an obstacle without contacting it. The access ramps allow objects to be moved from the floor or ground over the obstacle, first up one of the ramps, then across the central platform, then down the other of the ramps. When not being used, the access ramps may be folded upwards, with their distal sides brought together, thereby minimizing the floor space occupied by the portable ramp. Handles located at the distal portions of the access ramps allow for easy carrying of the portable ramp. The upper surface of the portable ramp may have a nonslip covering, for increased safety to persons walking over the portable ramp. It may also have safety graphics applied to its upper surface, providing visible indicators of the portable ramp in general and more particularly of the sides of the portable ramp.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims.

### DESCRIPTION OF THE DRAWINGS

FIG. 1A is a plan side view of one embodiment of the present invention, depicting the portable ramp as it is deployed for use.

FIG. 1B is a plan side view of another embodiment of the present invention, depicting the portable ramp as it is deployed for use.

FIG. 2 is a plan side view of the embodiment of the present invention shown in FIG. 1A, depicting the portable ramp with its access ramps folded up for storage.

FIG. 3 is a plan top view of the embodiment of the present invention shown in FIG. 1A, depicting the portable ramp as it is deployed for use.

FIG. 4 is an exploded perspective view of the embodiment of the present invention shown in FIG. 1B.

### DETAILED DESCRIPTION OF THE INVENTION

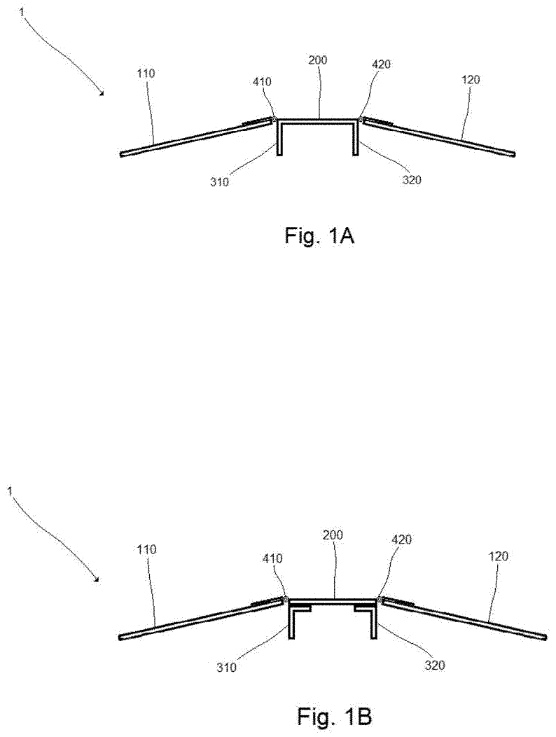

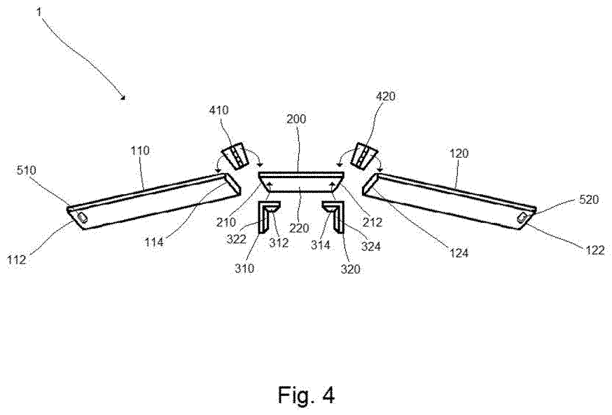

In one embodiment, the portable ramp 1 of the present invention is comprised of a central platform 200, a first support member 310, a second support member 320, a first access ramp 110, and a second access ramp 120. See FIGS. 1A, 1B, and 4. The first support member 310 is located on the underside 220 of the central platform 200 proximate to the first lateral side 210 of the central platform 200. The second support member 320 is located on the underside 220 of the central platform 200 proximate to the second lateral side 212 of the central platform 200. The first access ramp 110 is hingedly attached to the first lateral side 210 of the central platform 200 by a first hinge 410. The second access ramp 120 is hingedly attached to the second lateral side 212 of the central platform 200 by a second hinge 420.

In one embodiment, the central platform 200 of the portable ramp 1 is substantially planar and has a substantially rectangular shape. It may have any dimension, though in the preferred embodiments it has a width of between 6 inches and 12 inches and a length of between 24 inches and 36 inches. In the most preferred embodiment, it has a width of 8 inches and a length of 30 inches. The first lateral side 210 of the central platform 200 is one of the long sides of the central platform 200, and the second lateral side 212 of the central platform 200 is the opposite long side of the central platform 200. The central platform 200 must be constructed of a rigid, durable, high strength material. While any appropriate material may be used, in the preferred embodiment ¼ inch thick plate aluminum is used. This material is both light weight and can support several thousand pounds without distorting. There may be differing thicknesses for different applications, for example, a thinner plate may be used if keeping the overall weight of the ramp 1 to a minimum is a priority and lighter items are to be moved over the ramp 1, while a thicker plate may be used if heavier items are to be moved over the ramp 1.

The first support member 310 of the portable ramp 1 is elongate and substantially planar. It may have any dimension, though in the preferred embodiments it has a length of between 24 inches and 36 inches and a height of between 1 inch and 2 inches. In the most preferred embodiment, it has a length of 30 inches and a height of 1¾ inches. In all embodiments, the length of the first support member 310 should be substantially the same as the length of the central platform 200. The first support member 310 must be constructed of a rigid, durable, high strength material. The second support member 320 of the portable ramp 1 is configured substantially the same as the first support member 310, having the same dimensions and made of the same material. In one embodiment, the first support member 310 is monolithically integrated with the central platform 200, and the second support member 320 is monolithically integrated with the central platform 200. See FIG. 1A. In this embodiment, the central platform 200 may be C-channel aluminum plate.

In another embodiment, the first support member 310 may be a separate component that is fixedly attached to the underside of the central platform 200. See FIG. 1B. In this embodiment, while any appropriate material may be used, preferably ¼ inch thick angle aluminum is used. So configured, the first support member 310 is comprised of a horizontally oriented top plate 312 and a vertically oriented side plate 314, with the top plate 312 being substantially perpendicular to the side plate 314. In this embodiment, the second support member 320 of the portable ramp 1 is configured substantially the same as the first support member 310, having the same dimensions and made of the same material. The first support member 310 is located on the underside 220 of the central platform 200. The side plate 314 of the first support member 310 is oriented substantially parallel to the first lateral side 210 of the central platform 200 and is located proximate thereto. The top plate 312 of the first support member 310 is oriented inward from the first lateral side 210 of the central platform 200 and is fixedly attached to the underside 220 of the central platform 200. This may be accomplished by any suitable means, such as by the use of mechanical fasteners, including screws, bolts, and nuts. Preferably, the top plate 312 of the first support member 310 is welded to the underside 220 of the central platform 200. In the same manner, the side plate 324 of the second support member 320 is oriented substantially parallel to the second lateral side 212 of the central platform 200 and is located proximate thereto. The top plate 322 of the second support member 320 is oriented inward from the second lateral side 212 of the central platform 200 and is fixedly attached to the underside 220 of the central platform 200. Preferably, the top plate 322 of the second support member 320 is welded to the underside 220 of the central platform 200.

The first access ramp 110 of the portable ramp 1 is substantially planar and has a substantially rectangular shape. It may have any dimension, though in the preferred embodiments it has a width of between 12 inches and 24 inches and a length of between 24 inches and 36 inches. In the most preferred embodiment, it has a width of 18 inches and a length of 30 inches. In all embodiments, the length of the first access ramp 110 should be substantially the same as the length of the central platform 200. The first access ramp 110 must be constructed of a rigid, durable, high strength material. While any appropriate material may be used, in the preferred embodiment ¼ inch thick plate aluminum is used. There may be differing thicknesses for different applications, as described above. The second access ramp 120 of the portable ramp 1 is configured substantially the same as the first access ramp 110, having the same dimensions and made of the same material.

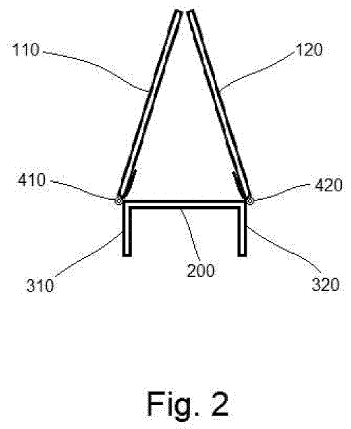

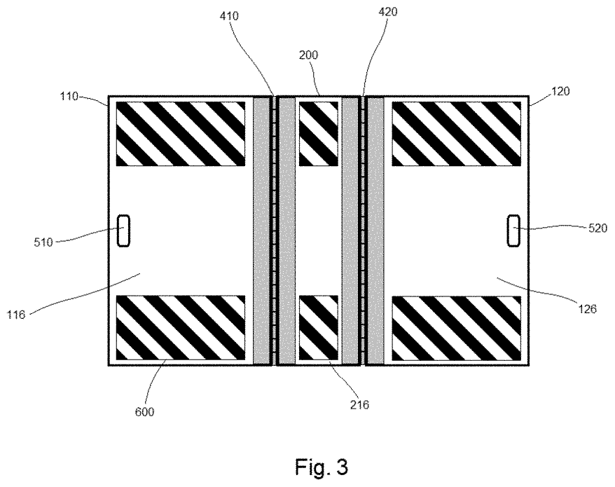

The first access ramp 110 is located proximate to the first lateral side 210 of the central platform 200. It is hingedly attached thereto, so that the first access ramp 110 is moveable in relation to the central platform 200. Specifically, the first access ramp 110 must be able to be folded upwards into a substantially vertical orientation. See FIG. 2. Any form of hinge may be used to attach the first access ramp 110 to the first lateral side 210 of the central platform 200. In one embodiment the first hinge 410 is a piano hinge. In the preferred embodiment, a single first hinge 410 having a length substantially the same as the length of the central platform 200 is used. In other embodiments, multiple smaller hinges may be linearly disposed along the first lateral side 210 of the central platform 200 and attached to the first access ramp 110. In all embodiments, the hinges should be durable and able to withstand significant stress, being capable of collectively bearing several thousand pounds of weight. The one or more hinges may be secured to the first access ramp 110 and to the central platform 200 by any suitable means. In one embodiment, mechanical fasteners may be used. In the preferred embodiment, the one or more hinges are welded to the proximate side 114 of the first access ramp 110 and to the first lateral side 210 of the central platform 200. The first access ramp 110 should be substantially aligned with the central platform 200, whereby the short sides of the first access ramp 110 are substantially aligned with the short sides of the central platform 200. See FIG. 3.

The second access ramp 120 is located proximate to the second lateral side 212 of the central platform 200. It is hingedly attached thereto, so that the second access ramp 120 is moveable in relation to the central platform 200. Specifically, the second access ramp 120 must be able to be folded upwards into a substantially vertical orientation. See FIG. 2. Any form of hinge may be used to attach the second access ramp 120 to the second lateral side 212 of the central platform 200. In one embodiment the second hinge 420 is a piano hinge. In the preferred embodiment, a single second hinge 420 having a length substantially the same as the length of the central platform 200 is used. In other embodiments, multiple smaller hinges may be linearly disposed along the second lateral side 212 of the central platform 200 and attached to the second access ramp 120. The one or more hinges may be secured to the second access ramp 120 and to the central platform 200 by any suitable means. In one embodiment, mechanical fasteners may be used. In the preferred embodiment, the one or more hinges are welded to the proximate side 124 of the second access ramp 120 and to the second lateral side 212 of the central platform 200. The second access ramp 120 should be substantially aligned with the central platform 200, whereby the short sides of the second access ramp 120 are substantially aligned with the short sides of the central platform 200. See FIG. 3.

Carrying handles may be formed into the first and second access ramps 110,120 proximate to their distal sides 112,122. In the preferred embodiment a first handle 510 is formed by creating an aperture through the first access ramp 110 at a location proximate to the distal side 112 of the first access ramp 110, located approximately midway between the short sides of the first access ramp 110. The aperture may be rectangular, or circular, or any other suitable shape. In the preferred embodiment the aperture is an elongate oval. See FIG. 3. Similarly, a second handle 520 is formed by creating an aperture through the second access ramp 120 at a location proximate to the distal side 122 of the second access ramp 120, located approximately midway between the short sides of the second access ramp 120. The second handle 520 may be configured and dimensioned the same as the first handle 510.

In other embodiments, a first handle 510 may be affixed to the underside of the first access ramp 110 proximate to the distal side 112 of the first access ramp 110, and a second handle 520 may be affixed to the underside of the second access ramp 120 proximate to the distal side 122 of the second access ramp 120. Any suitable configuration of handle may be used, though the height of the handles 510,520 must not be so great as to prevent the distal sides 112,122 of the access ramps 110,120 from coming into contact with the floor or ground when the portable ramp 1 is deployed for use. When the first and second access ramps 110,120 are folded upwards, their distal sides 112,122 come into close proximity to each other, see FIG. 2, allowing the first handle 510 and the second handle 520 to come into alignment with each other. A person can then grasp both handles 510,520 simultaneously in order to easily move the portable ramp 1.

The upper surfaces 116,126,216 of the central platform 200 and the two access ramps 110,120 may have a nonslip material placed thereon, to improve safety. Any suitable nonslip material may be used. The nonslip material may be affixed to the upper surfaces 116,126,216 of the central platform 200 and the two access ramps 110,120 by the use of an adhesive. The upper surfaces 116,126,216 of the central platform 200 and the two access ramps 110,120 may also have one or more safety graphics 600 affixed thereto. See FIG. 3. The safety graphics 600 may be of any standard design as is typically used in industry, so as to provide a visual indicator of the sides of the portable ramp 1 when it is deployed for use. This makes the portable ramp 1 more visible to others, so that persons will be less likely to trip over the portable ramp 1 or strike it with items being moved about in the general vicinity. The safety graphics 600 also aid the person traversing the portable ramp 1, so that the person does not inadvertently step off an edge.

The portable ramp 1 of the present invention is used as follows: typically, the portable ramp 1 will be stored in a safe location with its access ramps 110,120 folded upwards, as shown in FIG. 2. A user will grasp the portable ramp 1 by its handles, lift it, and carry it to the location where the obstacle needs to be traversed. The user positions the central platform 200 of the portable ramp 1 over the obstacle and sets it down, resting the first and second support members 310,320 on the floor or ground, so that the central platform 200 is located above the obstacle and the obstacle is located between the first and second support members 310,320 of the portable ramp 1. The first and second access ramps 110,120 are then lowered, so that their respective distal sides 112,122 rest on the floor or ground, as shown in FIG. 1. The user now moves whatever object is in need of traversing the obstacle up one of the access ramps, across the central platform 200, and down the other access ramp. When the portable ramp 1 is no longer needed, the first and second access ramps 110,120 are folded upwards into a vertical orientation, the user grasps the portable ramp 1 by its handles, lifts it, and carries it a new location.

These and other embodiments are contemplated by the present invention. While the preferred embodiments of the present invention have been described, modifications can be made and other embodiments may be devised without departing from the spirit of the invention.

I claim:

1. A portable ramp, said ramp comprising a central platform, a first support member, a second support member, a first access ramp, and a second access ramp,
wherein the first support member is located on an underside of the central platform,
the second support member is located on the underside of the central platform,
the first access ramp is hingedly attached to the central platform by a first hinge, and
the second access ramp is hingedly attached to the central platform by a second hinge.

2. The portable ramp of claim 1 wherein
the central platform is substantially planar and has a substantially rectangular shape, having two substantially parallel long sides and two substantially parallel short sides, with each short side oriented substantially perpendicular to each long side, wherein one long side of the central platform is designated a first lateral side of the central platform and the other long side of the central platform is designated a second lateral side of the central platform.

3. The portable ramp of claim 1 wherein
the first support member is elongate, substantially planar, and monolithically integrated with the central platform, and
the second support member is elongate, substantially planar, and monolithically integrated with the central platform.

4. The portable ramp of claim 2 wherein
the first support member is elongate and substantially planar and is comprised of a horizontally oriented top plate and a vertically oriented side plate, with said top plate being substantially perpendicular to said side plate, and
the second support member is elongate and substantially planar and is comprised of a horizontally oriented top plate and a vertically oriented side plate, with said top plate being substantially perpendicular to said side plate,
whereby the side plate of the first support member is oriented substantially parallel to the first lateral side of the central platform and is located proximate thereto, and the top plate of the first support member is fixedly attached to the underside of the central platform proximate to the first lateral side of the central platform, and
the side plate of the second support member is oriented substantially parallel to the second lateral side of the central platform and is located proximate thereto, and the top plate of the second support member is fixedly attached to the underside of the central platform proximate to the second lateral side of the central platform.

5. The portable ramp of claim 4 wherein the first support member and the second support member are each constructed of angle aluminum.

6. The portable ramp of claim 5 wherein the central platform is constructed of plate aluminum, and
the first support member is welded to the central platform and the second support member is welded the central platform.

7. The portable ramp of claim 2 wherein
the first access ramp is substantially planar and has a substantially rectangular shape, having two substantially parallel long sides and two substantially parallel short sides, with each short side oriented substantially perpendicular to each long side, wherein one long side of the first access ramp is designated a proximate side of the first access ramp and the other long side of the first access ramp is designated a distal side of the first access ramp, said distal side located opposite said proximate side, with said proximate side of the first access ramp being located proximate to the central platform, and
the second access ramp is substantially planar and has a substantially rectangular shape, having two substantially parallel long sides and two substantially parallel short sides, with each short side oriented substantially perpendicular to each long side, wherein one long side of the second access ramp is designated a proximate side of the second access ramp and the other long side of the second access ramp is designated a distal side of the second access ramp, said distal side located opposite said proximate side, with said proximate side of the second access ramp being located proximate to the central platform.

8. The portable ramp of claim 7 wherein the first access ramp and the second access ramp have the same size and dimensions.

9. The portable ramp of claim 7 wherein
the first hinge connects the first lateral side of the central platform to the proximate side of the first access ramp, and
the second hinge connects the second lateral side of the central platform to the proximate side of the second access ramp;
whereby the first hinge allows the first access ramp to move in relation to the central platform and the second hinge allows the second access ramp to move in relation to the central platform, such that the first access ramp has a deployed mode wherein the distal side of the first access ramp is in contact with a support surface and an undeployed mode wherein the first access ramp is oriented substantially vertically, and the second access ramp has a deployed mode wherein the distal side of the second access ramp is in contact with the support surface and an undeployed mode wherein the second access ramp is oriented substantially vertically.

10. The portable ramp of claim 9 wherein
the first hinge is substantially the same length as the first lateral side of the central platform, and
the second hinge is substantially the same length as the second lateral side of the central platform.

11. The portable ramp of claim 9 wherein
the first hinge is comprised of a plurality of subhinges, said subhinges being linearly disposed along the first lateral side of the central platform, and
the second hinge is comprised of a plurality of subhinges, said subhinges being linearly disposed along the second lateral side of the central platform.

12. The portable ramp of claim 11 wherein each subhinge in sized and dimensioned substantially the same as each other subhinge.

13. The portable ramp of claim 1 wherein the central platform, the first access ramp, and the second access ramp are each constructed of plate aluminum.

14. The portable ramp of claim 13 wherein
the first hinge is welded to the central platform and to the first access ramp, and
the second hinge is welded to the central platform and to the second access ramp.

15. The portable ramp of claim 1 wherein the first hinge is a piano hinge and the second hinge is a piano hinge.

16. The portable ramp of claim 7 wherein
a first handle is located on the first access ramp proximate to the distal side of the first access ramp, and
a second handle is located on the second access ramp proximate to the distal side of the second access ramp.

17. The portable ramp of claim 16 wherein the first handle is an aperture passing through the first access ramp and the second handle is an aperture passing through the second access ramp.

18. The portable ramp of claim 16 wherein the first handle is affixed to an underside of the first access ramp and the second handle is affixed to an underside of the second access ramp.

19. The portable ramp of claim 1 wherein
an upper surface of the central platform is at least partially covered by nonslip material,
an upper surface of the first access ramp is at least partially covered by nonslip material, and
an upper surface of the second access ramp is at least partially covered by nonslip material.

20. The portable ramp of claim 1 wherein
an upper surface of the central platform has affixed thereto one or more safety graphics,
an upper surface of the first access ramp has affixed thereto one or more safety graphics, and
an upper surface of the second access ramp has affixed thereto one or more safety graphics.
